(19) United States
(12) Patent Application Publication
(10) Pub. No.: US 2002/0165469 A1
(43) Pub. Date: Nov. 7, 2002

(54) Ultrasonic operating apparatus and tool for changing tip thereof

(75) Inventor: Eiji Murakami, Hachioji-shi (JP)

Correspondence Address: OSTROLENK FABER GERB & SOFFEN, 1180 AVENUE OF THE AMERICAS, NEW YORK, NY, 100368403

(73) Assignee: Olympus Optical Co., Ltd.

(21) Appl. No.: 10/074,787

(22) Filed: Feb. 12, 2002

(30) Foreign Application Priority Data
Feb. 13, 2001 (JP) 2001-035921

(51) Int. Cl. A61H 1/00

(52) U.S. Cl. 601/2

(57) ABSTRACT

According to the present invention, a jaw unit is provided with a frame-shaped jaw body and a tip for seizing an organism tissue in conjunction with an operating portion of a vibration transmitting member, and the tip is removably coupled between arms of the jaw body.

### CROSS-REFERENCE TO RELATED APPLICATIONS

This application is based upon and claims the benefit of priority from the prior Japanese Patent Application No. 2001-35921, filed Feb. 13, 2001, the entire contents of which are incorporated herein by reference.

### BACKGROUND OF THE INVENTION

The present invention relates to an ultrasonic operating apparatus capable of performing operation, such as incision, ablation, or coagulation of an organism tissue, by utilizing ultrasonic waves while seizing the organism tissue between an ultrasonic probe and a jaw, and a tool for changing a tip thereof.

An apparatus described in Jpn. Pat. Appln. KOKAI Publication No. 10-5236 or the like is an example of an ultrasonic operating apparatus that performs operation, such as incision, ablation, or coagulation of an organism tissue, by utilizing ultrasonic waves, in general. In this ultrasonic operating apparatus, a handling portion on the hand side is coupled to the proximal end portion of an insert portion covering tube. This handling portion is provided with an ultrasonic vibrator that generates ultrasonic vibration. Further, an operating portion for operating the organism tissue is provided on the distal end portion of the insert portion covering tube.

The insert portion covering tube is penetrated by a vibration transmitting member that transmits the ultrasonic vibration from the ultrasonic vibrator to an ultrasonic probe on the operating portion side. The proximal end portion of the vibration transmitting member is connected to the ultrasonic vibrator. Further, the operating portion is provided with a jaw that is rockably supported opposite the ultrasonic probe. A tip of the jaw that touches the organism tissue is formed of a plastic material such as Teflon (trademark).

The operating portion is provided with a control handle for opening and closing the jaw with respect to ultrasonic probe. Further, a handling rod of the jaw is inserted in the insert portion covering tube for axial movement. As the control handle is operated, the handling rod is advanced or retreated in the axial direction. In association with this movement of the handling rod, the jaw of the operating portion is opened or closed with respect to the ultrasonic probe. As the jaw is opened or closed, the organism tissue can be seized between the ultrasonic probe and the jaw. Subsequently, in this state, the ultrasonic vibration from the ultrasonic vibrator is transmitted to the ultrasonic probe on the operating portion side by means of the vibration transmitting member. Thus, operation, such as incision, ablation, or coagulation of the organism tissue, can be performed by utilizing ultrasonic waves.

The ultrasonic operating apparatus is repeatedly used in a plurality of operations. During operation, the ultrasonic vibration of the ultrasonic probe is transmitted to the jaw of the operating portion. Thus, the tip of the plastic material used in the jaw of the operating portion is gradually worn away with the passage of time. All other components around the jaw of the operating portion than the tip are more durable than the tip of the jaw. If the tip of the jaw is worn away and rendered unusable, therefore, the components other than the tip can be kept usable.

In the conventional configuration described above, however, all the jaw components including the tip are integrally combined and unitized. If the tip of the jaw is worn away and rendered unusable, therefore, all the parts that are combined with the jaw and unitized must be replaced. Accordingly, the cost of parts replacement increases, so that it is hard to lower the running cost of the ultrasonic operating apparatus.

Further, the ultrasonic coagulotomy apparatus described in Jpn. Pat. Appln. KOKAI Publication No. 10-5236 is provided with a rotation drive mechanism for rotating the jaw of the operating portion around the central axis of the ultrasonic probe. If the distal end portion of the ultrasonic probe of the operating portion is curved rightward or leftward with respect to the direction of the center line, directivity develops according to the curved shape of the ultrasonic probe of the operating portion.

On the actual scene of ultrasonic operation, for example, the ultrasonic probe sometimes may be expected to be turned upward or downward in the visual field of an endoscope, depending on the region to be operated. In such a case, the insert portion is rotated around its axis to move the ultrasonic probe in a desired direction by rotating a rotary knob of the operating portion in a desired direction.

With the above-described configuration, however, the direction of the ultrasonic probe at the distal end portion may be reversed despite the rotation of the insert portion, in some cases, so that use of the probe is not easy. Conventionally, to solve this problem, two differently oriented operating devices, e.g., a leftward-curve operating device and a rightward-curve operating device are prepared as separate bodies. The operating devices of the two types are suitably alternatively used by replacement, depending on working conditions such as the place of the region to be operated. In this case, therefore, it is necessary to separately prepare similar operating devices of the two types, left and right, having respective distal operating portions differently oriented, meaning that the whole ultrasonic operating apparatus is very expensive.

### BRIEF SUMMARY OF THE INVENTION

The present invention has been contrived in consideration of these circumstances, and its object is to provide an ultrasonic operating apparatus, designed so that the cost of the whole system can be lowered and the direction of a distal operating portion can be easily changed at low cost, and a tool for changing a tip thereof.

In order to achieve the above object, according to the present invention, there is provided an ultrasonic operating apparatus, which comprises: an elongate insert portion capable of being inserted into a body cavity; an operating portion located on a distal end portion of the insert portion, the operating portion being used to operate an organism tissue; a handling portion coupled to a proximal end portion of the insert portion, the handling portion having therein an ultrasonic vibrator capable of generating ultrasonic vibration; a covering tube located around the insert portion; a vibration transmitting member passed through the covering tube, the vibration transmitting member having an ultrasonic probe on a side of the operating portion and capable of transmitting the ultrasonic vibration from the ultrasonic vibrator to the ultrasonic probe; a jaw rockably supported opposite the ultrasonic probe and capable of seizing the organism tissue in conjunction with the ultrasonic probe; a control handle located in the handling portion and capable of opening and closing the jaw with respect to the ultrasonic probe; and a handling force transmitting member coupling the jaw and the control handle, and capable of transmitting handling force from the control handle to the jaw, the jaw including a frame-shaped jaw body having at least supporting arms arranged individually on the opposite sides of a slot extending in an axial direction of the insert portion, a tip capable of seizing the organism tissue in conjunction with the ultrasonic probe, and a joint portion removably coupling the tip between the supporting arms of the jaw body.

According to the present invention, the tip is removably coupled between the supporting arms of the jaw body of the jaw so that the tip can be removed from between the supporting arms if it is worn away, and thereafter, a new tip is mounted between the supporting arms for replacement. Further, two types of tips, left and right, having their respective distal operating portions directed differently, are suitably alternatively mounted between the supporting arms for replacement, depending on conditions such as the place of the region to be operated. Even in the case where the distal operating portion has an asymmetric portion with respect to the central axis of the insert portion and displays directivity as it rotates around the axis of the insert portion, the direction of the distal operating portion can be easily changed at low cost.

In the ultrasonic operating apparatus according to claim 1 of the present invention, moreover, the ultrasonic probe has an asymmetric curved portion curved with respect to the central axis of the insert portion covering tube.

According to the present invention, the position of the distal operating portion is deviated from a center position in the visual field of an endoscope by means of the curved portion of the ultrasonic probe, so that the distal operating portion is easily visible in the visual field of the endoscope.

In the ultrasonic operating apparatus according to claim 2 of the present invention, furthermore, the curved portion is formed symmetrically with respect to the direction in which the jaw is opened or closed.

Since the curved portion of the ultrasonic probe is formed symmetrically with respect to the direction in which the jaw is opened or closed, according to the present invention, the distal operating portion can be easily turned in two directions, left and right, by means of one apparatus, so that the number of operating apparatuses to be assorted can be reduced and the cost can be lowered.

In the ultrasonic operating apparatus according to claim 1 of the present invention, moreover, the jaw body is designed so that support shaft portions of the tip protrude inward from the respective distal end portions of the two supporting arms, and the tip has mounting holes into which the support shaft portions are removably inserted and guide grooves for guiding the support shaft portions to the mounting holes as the tip is attached to the jaw body, the guide grooves individually having taper surfaces for movement such that the space between the respective support shaft portions of the two supporting arms widens toward the mounting holes and click step portions for preventing the support shaft portions from slipping out of the mounting holes.

In attaching the tip to the jaw body, according to the present invention, the respective support shaft portions of the two supporting arms are guided along the guide grooves of the tip to the mounting holes. As the support shaft portions are moved along the guide grooves of the tip, they are moved in a direction such that the space between the respective support shaft portions of the two supporting arms widens toward the mounting holes. Then, the support shaft portions pass over the click steps at the junctions with the mounting holes and are inserted into the mounting holes of the tip. When the support shaft portions are coupled to the mounting holes of the tip, moreover, the click steps serve to prevent them from slipping out of the mounting holes.

A tool for changing a tip of an ultrasonic operating apparatus according to the present invention comprises: a tip changing tool body having an insertion hole into which a distal operating portion of the ultrasonic operating apparatus can be inserted and a stopper portion for locating the position of insertion of the distal operating portion inserted in the insertion hole; a handling arm coupled to the jig body so as to be rockable around a hinge portion located on the inlet side of the insertion hole of the jig body; and wedge-shaped separating portions adapted to be removably inserted into spaces between a tip for seizing an organism tissue and supporting arms on the opposite sides of a jaw body of the distal operating portion as the handling arm rocks, thereby moving the supporting arms in a direction such that indented fitting portions of the supporting arms and the tip are disengaged from one another.

In removing the tip from the jaw body, according to the present invention, the position of insertion of the distal operating portion of the ultrasonic operating apparatus is located by means of the stopper portion with the distal operating portion inserted in the insertion hole of the tip changing tool body. In this state, the handling arm is rocked around the hinge portion on the inlet side of the insertion hole of the jaw body with respect to the jig body. As the handling arm is rocked in this manner, the wedge-shaped separating portions are inserted into the spaces between the tip for seizing the organism tissue and the supporting arms on the opposite sides of the jaw body of the distal operating portion, whereby the supporting arms are moved in a direction such that the indented fitting portions of the supporting arms and the tip are disengaged from one another. By doing this, the tip is removed from the jaw body.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a side view showing an assembled state of the whole body of an ultrasonic operating apparatus of a first embodiment of the present embodiment;

FIG. 2 is a longitudinal sectional view showing the internal configuration of a handling portion in the ultrasonic operating apparatus of the first embodiment;

FIG. 3 is a sectional view taken along line III-III of FIG. 2;

FIG. 4 is a sectional view taken along line IV-IV of FIG. 2;

FIG. 5A is a side view showing a probe unit of the ultrasonic operating apparatus of the first embodiment;

FIG. 5B is a sectional view taken along line 5B-5B of FIG. 5A;

FIG. 5C is a sectional view taken along line 5C-5C of FIG. 5A;

FIG. 5D is a sectional view taken along line 5D-5D of FIG. 5A;

FIG. 5E is a sectional view taken along line 5E-5E of FIG. 5A;

FIG. 6 is an exploded perspective view of the distal end portion of an insert portion of a handle unit in the ultrasonic operating apparatus of the first embodiment;

FIG. 7 longitudinal sectional view showing detailed configuration of a distal operating portion of the ultrasonic operating apparatus of the first embodiment;

FIG. 8A is a sectional view taken along line 8A-8A of FIG. 7;

FIG. 8B is a sectional view taken along line 8B-8B of FIG. 7;

FIG. 8C is a sectional view taken along line 8C-8C of FIG. 7;

FIG. 8D is a sectional view taken along line 8D-8D of FIG. 7;

FIG. 9 is a plan view showing a curved state of a jaw unit in the ultrasonic operating apparatus of the first embodiment;

FIG. 10 is a side view showing a closed state of the jaw unit in the ultrasonic operating apparatus of the first embodiment;

FIG. 11A is a plan view showing a curved portion of an operating portion of the probe unit in the ultrasonic operating apparatus of the first embodiment;

FIG. 11B is a sectional view taken along line 11B-11B of FIG. 11A;

FIG. 11C is a side view showing the curved portion of the operating portion;

FIG. 12 is a longitudinal sectional view of a principal part showing the internal configuration of portions surrounding a rotary knob in the ultrasonic operating apparatus of the first embodiment;

FIG. 13A is a plan view showing a distal operating portion of an ultrasonic operating apparatus according to a second embodiment of the present invention;

FIG. 13B is a side view of the distal operating portion;

FIG. 14A is a front view of a rightward-curve ultrasonic probe in the ultrasonic operating apparatus of the second embodiment;

FIG. 14B is a side view of the rightward-curve ultrasonic probe;

FIG. 14C is a front view of a leftward-curve ultrasonic probe;

FIG. 14D is a side view of the leftward-curve ultrasonic probe;

FIG. 15 is a side view of a jaw unit in the ultrasonic operating apparatus of the second embodiment;

FIG. 16 is a sectional view taken along line 16-16 of FIG. 15;

FIG. 17 is a plan view, partially in section, showing a jaw body in the ultrasonic operating apparatus of the second embodiment;

FIG. 18A is a plan view showing a tip changing tool in the ultrasonic operating apparatus of the second embodiment;

FIG. 18B is a side view of a jig body;

FIG. 19A is a plan view showing a state in which the operating portion of the ultrasonic operating apparatus of the second embodiment is inserted in the tip changing tool of the ultrasonic operating apparatus;

FIG. 19B is a side view showing the same state;

FIG. 20A is a sectional view taken along line 20A-20A of FIG. 19B; and

FIG. 20B is a longitudinal sectional view of a principal part for illustrating operation for combining the jaw body and a tip of the second embodiment.

### DETAILED DESCRIPTION OF THE INVENTION

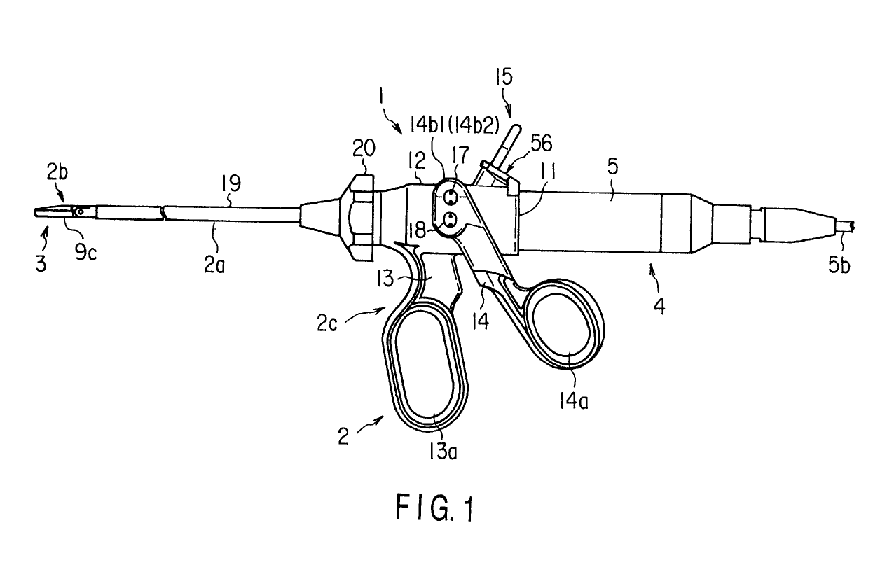

A first embodiment of the present invention will now be described with reference to FIGS. 1 to 12. FIG. 1 shows an assembled state of the whole body of an ultrasonic operating apparatus 1 of the present embodiment. This ultrasonic operating apparatus 1 comprises three assembly units that can be disassembled into three units, that is, a handle unit (handling portion) 2, a probe unit 3, and a vibrator unit 4. These three units 2 to 4 can be assembled into the state shown in FIG. 1.

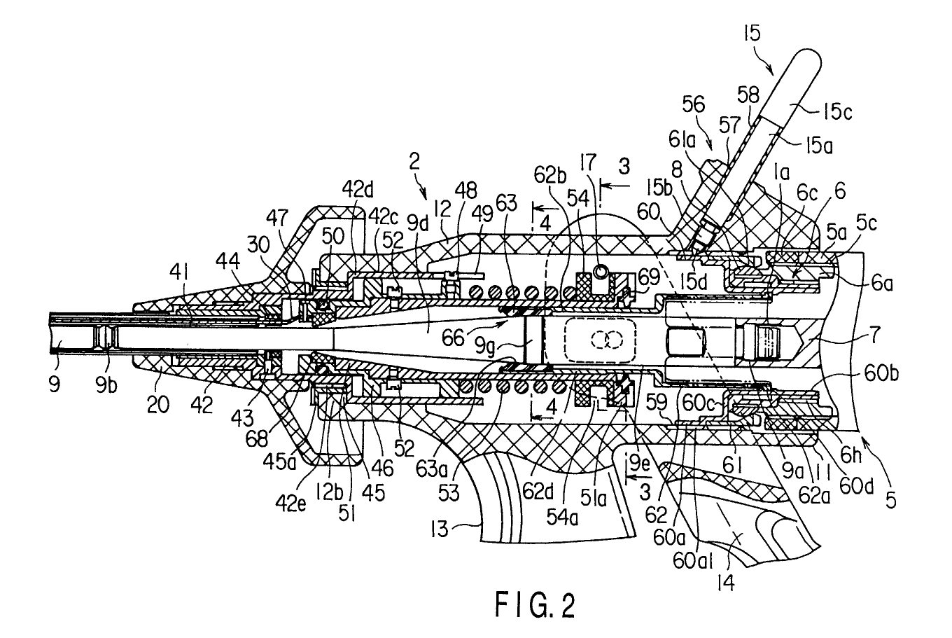

As shown in FIG. 2, the vibrator unit 4 has therein an ultrasonic vibrator (not shown) that generates ultrasonic vibration in a cylindrical vibrator cover 5a. Further, the proximal end portion of a horn 7 for enlarging the amplitude of ultrasonic vibration is coupled to the distal end portion of the ultrasonic vibrator. The distal end portion of the horn 7 is formed having a probe mounting tapped hole portion 7a.

Further, one end portion of a hand piece cord 5b for supplying current from a power source body (not shown) is connected to the rear end portion of the vibrator cover 5a. A hand piece plug (not shown) for connection to the power source body is connected to the other end portion of the hand piece cord 5b.

As shown in FIG. 2, a unit joint portion 6 for attachment and detachment of the handle unit 2 is attached to the distal end portion of the vibrator unit 4. The unit joint portion 6 is provided with a connecting ring 6a, ring-shaped attachment member 6b, fixing ring 6c, and engaging ring 8. An attachment mounting tapped hole portion 5c is formed in the inner peripheral surface of the distal end portion of the vibrator cover 5a. An external thread portion on the outer peripheral surface of the connecting ring 6a is screwed in the tapped hole portion 5c. Further, the fixing ring 6c is screwed on the distal end portion of the external thread portion of the connecting ring 6a.

Further, the outer peripheral surface of the proximal end portion of the attachment member 6b is screwed in the inner peripheral surface of the connecting ring 6a. The engaging ring 8 is fitted on the outer peripheral surface of the distal end portion of the attachment member 6b. The engaging ring 8 is formed of a so-called C-ring having the shape of a C obtained by cutting off a part of a ring. As shown in FIG. 2, the sectional shape of the engaging ring 8 is a substantially semilunar sectional shape such that its outer periphery is in the shape of a circular arc. This unit joint portion 6 can be detachably coupled to a vibrator connecting portion 11 of a handling portion body 12 (mentioned later) of the handle unit 2.

As shown in FIG. 5A, moreover, the probe unit 3 is provided with a vibration transmitting member 9 substantially in the form of an elongate rod that is detachably coupled to the tapped hole portion 7a on the distal end side of the horn 7 of the vibrator unit 4. The proximal end portion of the vibration transmitting member 9 is formed having a mounting screw 9a that is coupled to the tapped hole portion 7a of the horn 7. The mounting screw 9a is fixed to the tapped hole portion 7a of the horn 7 of the vibrator unit 4 by screwing. Thus, the probe unit 3 and the vibrator unit 4 are united together.

Further, rubber rings 9b, flange-shaped supports formed of a ring-shaped elastic member each, are provided individually in positions (a plurality of spots) for nodes of ultrasonic vibration that is transmitted from the side of the probe unit 3.

Further, an operating portion (ultrasonic probe) 9c is provided on the extreme distal end portion of the vibration transmitting member 9 of the present embodiment. As shown in FIG. 11A, the ultrasonic probe 9c is formed having a curved portion 10 in an asymmetric shape, e.g., the shape of a circular arc, which is curved away from a central axis 01, as shown in FIG. 11A.

As shown in FIG. 1, moreover, the handle unit 2 is composed of an elongate insert sheath portion 2a, a distal working portion 2b on the distal end portion of the insert sheath portion 2a, and a handing portion 2c on the proximal end portion of the insert sheath portion 2a. The handing portion 2c of the handle unit 2 is provided with the handling portion body 12 that is substantially cylindrical. The vibrator connecting portion 11 is formed on the proximal end portion of the handling portion body 12.

Further, a stationary handle 13 and a movable handle (handling means) 14 capable of rocking motion are provided on the outer peripheral surface of the handling portion body 12. Furthermore, an electrode pin 15 for high-frequency connection is attached to the top of the proximal end portion of the handling portion body 12 in a manner such that it is inclined backward.

The upper part of the stationary handle 13 is molded integrally with the cylindrical handling portion body 12. Further, the handling end portion of the stationary handle 13 is provided with a finger ring 13a in which a plurality of fingers other than the thumb can be selectively inserted, and the handling end portion of the movable handle 14 is provided with a finger ring 14a on which the thumb of the same hand can be hooked.

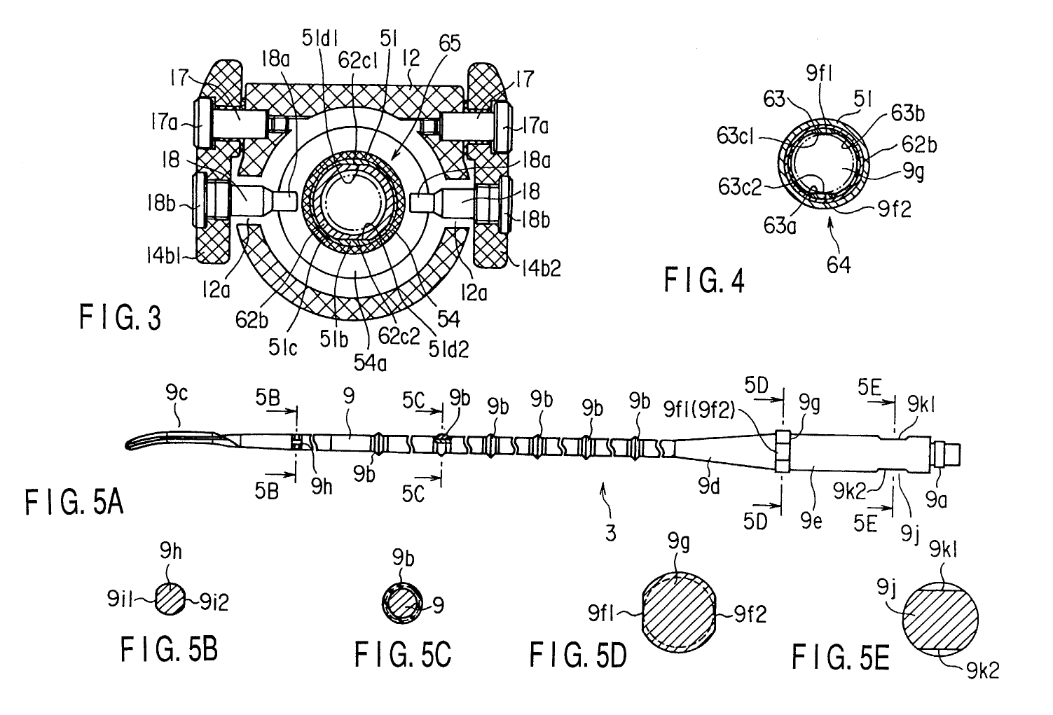

Bifurcate joint portions 14b1 and 14b2 are formed on the upper end side of the movable handle 14. As shown in FIG. 3, these bifurcate joint portions 14b1 and 14b2 are located individually on the opposite sides of the handling portion body 12. Further, the handle pivots 17 protrude inward from the respective upper end portions of the joint portions 14b1 and 14b2, individually. These handle pivots 17 are coupled to the handling portion body 12 at pivotal points above the axis of an insert portion covering tube 19 (mentioned later). Thus, the movable handle 14 is rockably supported by means of the handle pivots 17. The left- and right-hand handle pivots 17 are separately mounted so as not to project into the handling portion body 12. An insulating cap 17a for high-frequency insulation is attached to each handle pivot 17.

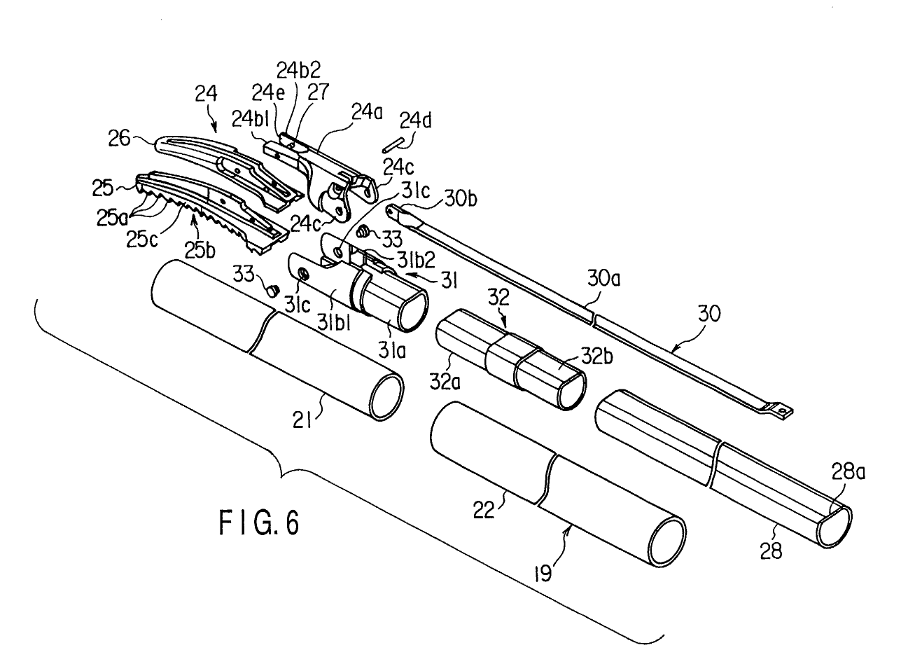

Further, actuator pins 18 for transmitting moving force to a handling rod (handling force transmitting member) 30 (mentioned later, see FIG. 6) project individually inward from the joint portions 14b1 and 14b2 of the movable handle 14 in regions near the handle pivots 17. These actuator pins 18 are located substantially on the axis of the insert portion covering tube 19. Windows 12a for the insertion of the actuator pins 18 are formed in the handling portion body 12. The actuator pins 18 of the movable handle 14 extend into the handling portion body 12 through the windows 12a of the handling portion body 12.

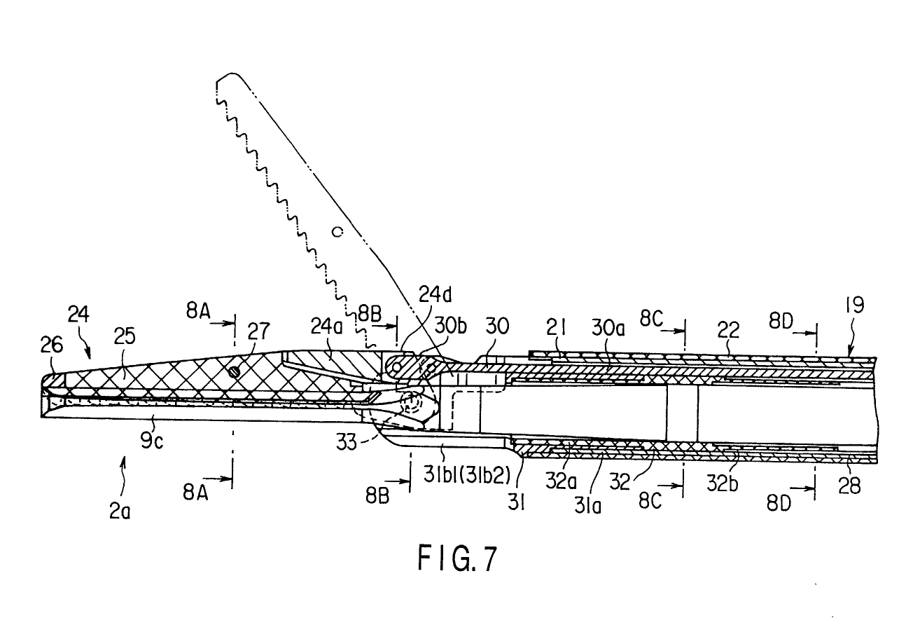

Furthermore, the insert sheath portion 2a is provided with the insert portion covering tube 19. The proximal end portion of the insert portion covering tube 19, along with a rotary knob (rotation drive mechanism) 20, is mounted on the distal end portion of the handling portion body 12 for rotation around the central axis of the insert portion covering tube 19. As shown in FIG. 7, the insert portion covering tube 19 is formed by fitting an insulating tube 22 on the outer peripheral surface of an outer pipe 21 that is formed of a metallic pipe. The insulating tube 22 is provided on the whole outer peripheral surface of the insert portion covering tube 19 so as to cover the greater part that reaches the proximal end portion.

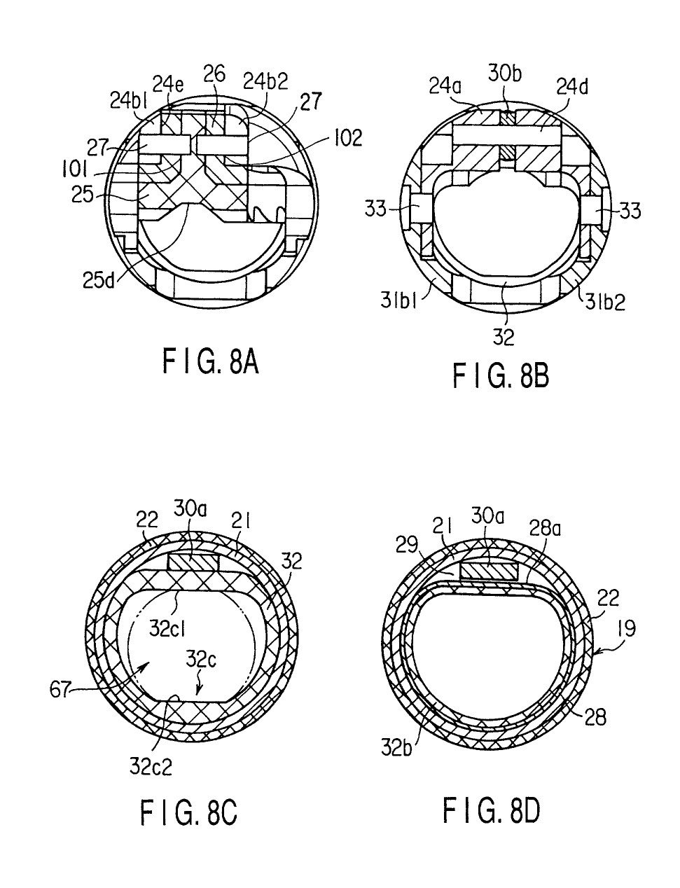

Further, a single-swing jaw unit 24 for seizing an organism tissue is rotatably attached to the distal working portion 2b of the handle unit 2. As shown in FIGS. 6 and 8B, the jaw unit 24 is provided with a substantially U-shaped jaw body 24a, a tip 25 for seizing an object (organ), and a seizing portion mounting member 26.

Furthermore, leg portions 24c that are bent diagonally backward, as shown in FIG. 6, are formed individually on the respective proximal end portions of a pair of U-shaped arms (supporting arms) 24b1 and 24b2 of the jaw body 24a.

As shown in FIG. 8A, moreover, the respective outer end portions of supporting pins (support shaft portions) 27 for supporting the tip 25 are fixed individually to the respective distal end portions of the arms 24b1 and 24b2 of the jaw body 24a. The supporting pins 27 project inside the arms 24b1 and 24b2, individually. As shown in FIG. 8B, moreover, a coupling pin 24d for connection with a handling rod 30 (mentioned later) is inserted in the respective upper edge portions of the leg portions 24c of the jaw body 24a.

The tip 25 is attached to a slit 24e between the arms 24b1 and 24b2 of the jaw body 24a by means of the seizing portion mounting member 26. The tip 25 is formed of a low-friction material such as PTFE (Teflon: trademark).

As shown in FIG. 8A, moreover, the tip 25 and the seizing portion mounting member 26 are formed having insertion holes 101 and 102, respectively, for the supporting pins 27. In assembling the jaw unit 24, the supporting pins 27 of the jaw body 24a are removably inserted into insertion holes 101 and 102 of the tip 25 and the seizing portion mounting member 26 and are removably coupled thereto. Thus, the tip 25 and the seizing portion mounting member 26 are swingably supported on the jaw body 24a by means of the supporting pins 27. When the tip 25 of the jaw unit 24 is pressed against the operating portion 9c of the vibration transmitting member 9 as the jaw unit 24 is closed, the tip 25 of the jaw unit 24 is caused to swing around the supporting pins 27, following the deflection of the operating portion 9c, so that the object (organ) can be seized with a uniform force by means of the whole contact portion between the tip 25 and the operating portion 9c.

Further, a plurality of nonskid teeth 25a are arranged on a contact surface of the tip 25 that touches the organism tissue as an object of coagulotomy, whereby a serrated nonslip tooth portion 25b is formed. The organism tissue as the object of coagulotomy can be seized without a slip by means of the nonskid tooth portion 25b of the tip 25.

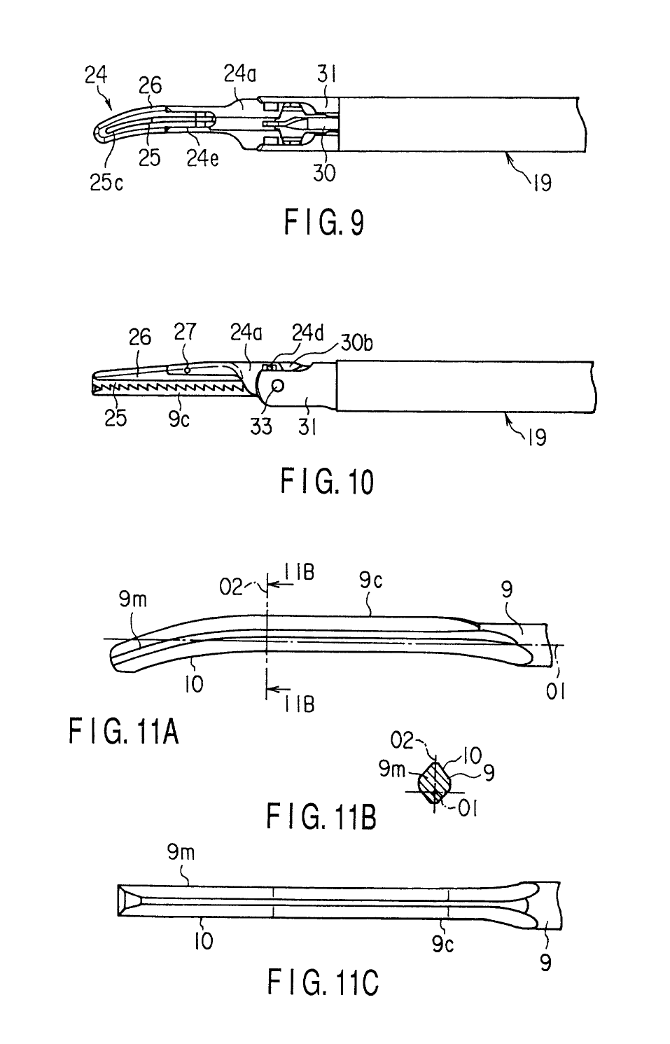

As shown in FIGS. 6 and 9, a curved portion 25c in the shape of a circular arc corresponding to the curved portion 10 of the vibration transmitting member 9 is formed on that surface of the tip 25 of the jaw unit 24 of the present embodiment which is opposed to the operating portion 9c of the vibration transmitting member 9. As shown in FIG. 8A, moreover, a seizing surface 25d in the shape of a recess corresponding to the shape (see FIG. 11B) of a contact surface 9m of the operating portion 9c of the vibration transmitting member 9 is formed on that surface of the tip 25 which is opposed to the operating portion 9c. When the jaw unit 24 is in its fully-closed position, the seizing surface 25d on the underside of the tip 25 is intimately in contact with the contact surface 9m of the operating portion 9c of the vibration transmitting member 9 without a gap.

An inner pipe 28 for use as a channel pipe is passed through the interior of the insert portion covering tube 19. As shown in FIGS. 6 and 8D, the inner pipe 28 has a substantially D-shaped cross section that includes a flat portion 28a formed in a part of a circular outer peripheral surface. The vibration transmitting member 9 of the probe unit 3 is passed through the inner pipe 28. Further, a sub-channel 29, a crescent space, is formed between the insert portion covering tube 19 and the flat portion 28a of the inner pipe 28. The handling rod 30 that transmits handling force for opening and closing the jaw unit 24 is movably passed through the sub-channel 29.

As shown in FIG. 6, this handling rod 30 has a rod body 30a that is formed of a substantially level platelike member. Further, the distal end portion of the handling rod 30 is formed having an upright jaw joint portion 30b that is obtained by twisting the flat rod body 30a at about 90°. The jaw joint portion 30b and the respective upper edge portions of the leg portions 24c are rockably coupled by means of the coupling pin 24d.

A jaw holding member 31 for holding the jaw unit 24 is attached to the distal end portion of the insert portion covering tube 19. As shown in FIG. 6, a substantially tubular fit-fixing portion 31a is formed on the proximal end portion of the jaw holding member 31. The fit-fixing portion 31a of the jaw holding member 31 is fixed by fitting to a distal end portion 32a of the coupling pipe 32 that is located in the insert portion covering tube 19. Further, the distal end portion of the inner pipe 28 is coupled to a proximal end portion 32b of the coupling pipe 32.

As shown in FIG. 8B, moreover, a pair of arm-shaped jaw mounting portions 31b1 and 31b2, left and right, are formed on the distal end portion of the jaw holding member 31. Further, pivot holes 31c are formed in the jaw mounting portions 31b1 and 31b2, individually. Pivot pins 33 that serve as pivots of the jaw body 24a are fitted individually in the respective pivot holes 31c of the jaw mounting portions 31b1 and 31b2. The jaw body 24a is mounted on the jaw holding member 31 for rotation around the pivot pins 33 as pivots. Thus, the jaw unit 24 can be opened or closed as the handling rod 30 is moved in the axial direction. The jaw unit 24 is closed when the handling rod 30 is pushed toward the distal end. In closing the jaw unit 24, the tip 25 of the jaw unit 24 is pressed against the operating portion 9c of the vibration transmitting member 9 of the probe unit 3, whereby the object (organ) can be seized between the operating portion 9c and the tip 25 of the jaw unit 24. The jaw unit 24 is also used to separate the organism tissue.

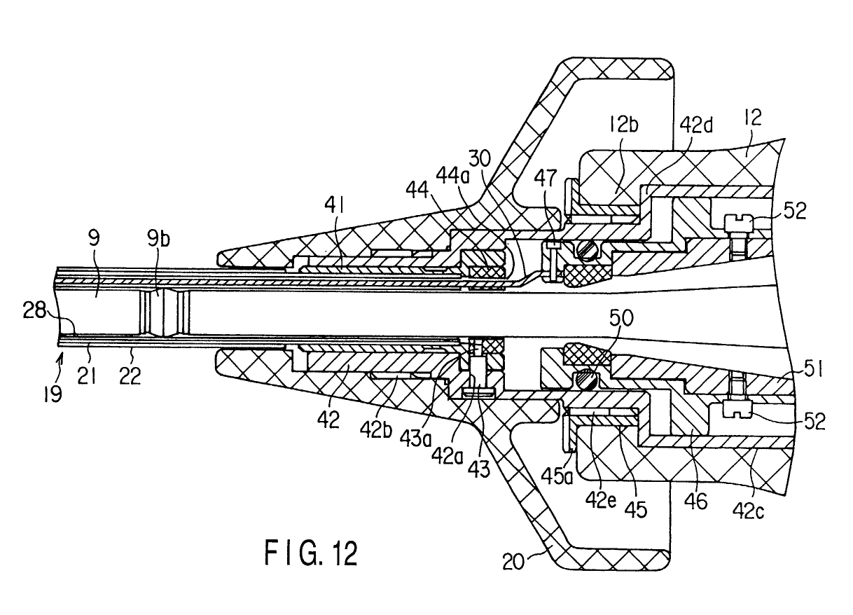

As shown in FIG. 12, a pipe fixing member 41 is fixed to the outer peripheral surface of the proximal end portion of the outer pipe 21 of the insert portion covering tube 19. A substantially cylindrical eccentric barrel 42 is mounted on the outer peripheral surface of the pipe fixing member 41. The center line of the eccentric barrel 42 is eccentric to the center line of the insert portion covering tube 19.

Further, a pit portion 42a is bored radially in the proximal end portion of eccentric barrel 42. A guide pin 43 is inserted in the pit portion 42a. The distal end portion of the guide pin 43 is fitted in the proximal end portion of the pipe fixing member 41.

Furthermore, a retaining ring 44 of a plastic material is fitted on the proximal end portion of the pipe fixing member 41. The inner peripheral surface of the retaining ring 44 has a diameter smaller than the inside diameter of the inner pipe 28. Thus, the metallic inner pipe 28 can be prevented from directly touching the vibration transmitting member 9. A handling rod passage hole 44a is formed in the retaining ring 44. The proximal end portion of the handling rod 30 is passed through the passage hole 44a.

Further, the retaining ring 44 is fitted with a small-diameter distal end protrusion 43a that protrudes from the distal end portion of the guide pin 43. Thus, the respective rotational-direction positions of the outer pipe 21 of the insert portion covering tube 19, pipe fixing member 41, eccentric barrel 42, and retaining ring 44 are regulated by means of the guide pin 43.

Furthermore, a rotary knob mounting screw portion 42b in the form of an external thread is formed on the outer peripheral surface of the eccentric barrel 42. This rotary knob mounting screw portion 42b is mated with an internal thread portion formed on the inner peripheral surface of the rotary knob 20 and is fitted with the rotary knob 20. Thus, as the rotary knob 20 rotates, the turning force of the rotary knob 20 is transmitted to the guide pin 43, pipe fixing member 41, retaining ring 44, the outer pipe 21 of the insert portion covering tube 19, and inner pipe 28, as well as to the eccentric barrel 42, whereupon these elements are rotated integrally with the rotary knob 20.

As shown in FIG. 2, moreover, a large-diameter rotating barrel portion 42c that extends to the interior of the handling portion body 12 is located on the proximal end side of the eccentric barrel 42. FIG. 2 shows the internal configuration of the handle unit 2. An inwardly bent flange portion 12b protrudes from the front end portion of the handling portion body 12.

Further, a substantially cylindrical rotating barrel portion 42c is fitted into the distal end opening of the handling portion body 12 from behind. As shown in FIG. 3, the rotating barrel portion 42c is formed having a first external thread portion 42e that has an inside diameter smaller than that of the flange portion 12b of the handling portion body 12 and is situated ahead of a shoulder portion 42d in engagement with the inner surface of the flange portion 12b.

Furthermore, a fixing ring 45 is screwed from the front side into the space between the flange portion 12b and the first external thread portion 42e of the rotating barrel portion 42c that is inserted in the handling portion body 12. The fixing ring 45 is in mesh with the first external thread portion 42e of the rotating barrel portion 42c. The flange portion 12b on the front end of the handling portion body 12 is held between a flange portion 45a on the distal end of the fixing ring 45 and the shoulder portion 42d of the rotating barrel portion 42c.

When the insertion end portion of the fixing ring 45 is in engagement with the shoulder portion 42d of the rotating barrel portion 42c, the distance between the shoulder portion 42d of the rotating barrel portion 42c and the proximal-end-side end face of the flange portion 45a of the fixing ring 45 is a little greater than the axial direction of the flange portion 12b. Thus, the rotating barrel portion 42c and the fixing ring 45 can be integrally rotated with respect to the flange portion 12b. The eccentric barrel 42 that has the diameter smaller than that of the first external thread portion 42e is coupled to the distal end portion of the rotating barrel portion 42c.

Further, a drive shaft connecting member (advancing/retreating member) 46 is inserted in the rotating barrel portion 42c for movement along the center line of the insert portion covering tube 19. The proximal end portion of the handling rod 30 is fixed to the distal end portion of the drive shaft connecting member 46 by means of a fixing pin 47.

Furthermore, a rotary fixing pin 48 protrudes from the proximal end portion of the drive shaft connecting member 46. The outer end portion of the rotary fixing pin 48 is inserted in a slot-shaped engaging groove 49 that is formed in the proximal end portion of the rotating barrel portion 42c. The engaging groove 49 extends in the axial direction of the insert portion covering tube 19. The rotating barrel portion 42c and the drive shaft connecting member 46 are relatively movable in the direction and are prevented from moving relatively to each other in the rotating direction by the rotary fixing pin 48.

When the rotary knob 20 is rotated, therefore, the force to rotate the rotary knob 20 is transmitted from the rotating barrel portion 42c rotating integrally with the eccentric barrel 42 to the drive shaft connecting member 46 via the rotary fixing pin 48. Thus, members that include the insert portion covering tube 19 and the members therein, the eccentric barrel 42 and the rotating barrel portion 42c mounted on the proximal end portion of the insert portion covering tube 19, and the rotary knob 20 can rotate integrally with the drive shaft connecting member 46 with respect to the handling portion body 12.

Further, an O-ring 50 is fitted on the outer peripheral surface of the drive shaft connecting member 46. The O-ring 50 serves to maintain airtightness between the rotating barrel portion 42c and the outer peripheral surface of the drive shaft connecting member 46.

Furthermore, the distal end portion of a slider mounting member 51 is screwed to the inner peripheral surface of the drive shaft connecting member 46 by means of fixing screws 52. An outward flange portion 51a that is bent outward protrudes from the proximal end portion of the slider mounting member 51.

Further, a limiting spring 53 formed of a coil spring and a ring-shaped slider 54 for spring bearing are arranged on the outer peripheral surface of the slider mounting member 51. The limiting spring 53 is mounted between the drive shaft connecting member 46 and the slider 54. The limiting spring 53 is compressed to be shorter than its free length and subjected to an equipment load as it is set in position.

Furthermore, a ring-shaped engaging groove 54a that engages the movable handle 14 is formed on the outer peripheral surface of the slider 54. As shown in FIG. 3, the respective inner end portions of the actuator pins 18 of the joint portions 14b1 and 14b2 of the movable handle 14 are inserted into the engaging groove 54a through the windows 12a of the handling portion body 12, individually. Small-diameter distal end engaging portions 18a corresponding in size to the groove width of the engaging groove 54a of the slider 54 are formed individually on the respective inner end portions of the actuator pins 18. The distal end engaging portions 18a of the actuator pins 18 are inserted into the engaging groove 54a of the slider 54 and engage the engaging groove 54a so as to be slidable in the circumferential direction along it. The actuator pins 18 are screwed to the joint portions 14b1 and 14b2 of the movable handle 14, individually. Further, an insulating cap 18b for high-frequency insulation is attached to the outer end portion of each actuator pin 18.

When the movable handle 14 is gripped (closing operation), the actuator pins 18 are rotated in the clockwise direction of FIG. 1 around the handle pivots 17. As this is done, the actuator pins 18 are advanced substantially straight to the distal end side within the ranges of movement of the actuator pins 18. This motion of the actuator pins 18 causes the slider 54 to advance toward the distal end. Further, this advancing motion of the slider 54 is transmitted from the slider mounting member 51 to the drive shaft connecting member 46 by means of the fixing screws 52, and the handling rod 30 is pushed out toward the distal end by means of the drive shaft connecting member 46. Since the limiting spring 53 is compressed to be shorter than its free length and subjected to the equipment load as it is mounted, it can directly cause the jaw unit 24 to open or close without undergoing elastic deformation with a handle operating force lighter than the equipment load, thereby improving the handling. If a force heavier than the equipment load of the limiting spring 53 is applied, the limiting spring 53 is elastically deformed to prevent further transmission of the handle operating force. In consequence, the force from the jaw unit 24 that acts on the operating portion 9c of the vibration transmitting member 9 can never be excessive, so that excessive displacement of the operating portion 9c can be prevented to maintain functions for incision and coagulation.

As shown in FIG. 1, moreover, an electrode mounting portion 56 for the connection of a high-frequency cable is formed on the vibrator connecting portion 11 of the handling portion body 12. As shown in FIG. 2, an electrode pin mounting hole 57 is formed in the electrode mounting portion 56. The electrode pin 15 is attached to the electrode pin mounting hole 57. A fixing screw 15b is formed on the proximal end portion of a pin body 15a of the electrode pin 15. Further, a connecting portion 15c for the connection of a high-frequency cable (not shown) is formed on the distal end portion of the pin body 15a. With an electrode insulating cover 58 mounted on an intermediate portion of the pin body 15a, the electrode pin 15 is attached to the electrode pin mounting hole 57 by means of the fixing screw 15b. A conic point portion 15d is formed on the opposite side of the electrode pin 15 to the connecting portion 15c.

Further, the inner peripheral surface of the proximal end portion of the handling portion body 12 is formed having a tapped hole portion 59 for mounting a retaining member to which the unit joint portion 6 of the vibrator unit 4 is releasably anchored as the vibrator unit 4 is coupled thereto. A substantially ring-shaped connecting member 60, formed of a conductive material such as metal, and a fixing ring 61 are successively screwed into the tapped hole portion 59.

Furthermore, the connecting member 60 is provided with an outer tube portion 60a, an inner tube portion 60b projecting backward beyond the outer tube portion 60a, and a joint portion 60c connecting the outer tube portion 60a and the inner tube portion 60b. The outer peripheral surface of the outer tube portion 60a of the connecting member 60 is formed having an external thread portion 60a1 that mates with the tapped hole portion 59 of the handling portion body 12. The connecting member 60 is attached to the tapped hole portion 59 of the handling portion body 12 by means of the external thread portion 60a1 so that its position is adjustable in the axial direction. After its position is adjusted, the connecting member 60 is fixed by means of the fixing ring 61 in the tapped hole portion 59 of the handling portion body 12. The electrode pin 15 is designed so that the point portion 15d can be butted for conduction against the external thread portion 60a1 on the outer periphery of the connecting member 60.

Further, a substantially conic engaging protuberance 61a protrudes from the inner peripheral surface of the proximal end portion of the fixing ring 61. In assembling the handle unit 2, probe unit 3, and vibrator unit 4 of the ultrasonic operating apparatus 1, the probe unit 3 and the vibrator unit 4 are integrally combined in advance, and the resulting combined unit is then combined with the handle unit 2. As this is done, the combined unit of the probe unit 3 and the vibrator unit 4 is inserted into the handle unit 2 through a rear end opening of the inner tube portion 60b of the connecting member 60, and is then inserted into the inner pipe 28 of the insert portion covering tube 19.

As shown in FIG. 1, the operating portion 9c on the extreme distal end portion of the probe unit 3 projects forward from the insert sheath portion 2a, and is set in a state such that it can seize the organism tissue between itself and the jaw unit 24. In this state, the unit joint portion 6 of a hand piece 5 of the vibrator unit 4 can be removably coupled to the vibrator connecting portion 11 of the handling portion body 12 of the handle unit 2.

In coupling the unit joint portion 6, moreover, the unit joint portion 6 is inserted along the outer peripheral surface of the inner tube portion 60b of the connecting member 60 toward the distal end, as shown in FIG. 2. At this time, the engaging ring 8 of the unit joint portion 6 is elastically deformed as it gets over the engaging protuberance 61a of the fixing ring 61 of the vibrator connecting portion 11. When the distal end face of the unit joint portion 6 engages a contact surface of the joint portion 60c on the proximal end side of the connecting member 60, the engaging ring 8 is pressed against the engaging protuberance 61a of the fixing ring 61 by elastic force, thereby generating frictional force. Thereupon, the unit joint portion 6 is detachably fixed to the vibrator connecting portion 11.

Located in the handling portion body 12 is a cylindrical conductive tube 62 of a conductive material such as metal that electrically conducts to the connecting member 60. The conductive tube 62 is formed having a plurality of slits that axially extend from an intermediate portion toward the proximal end portion and are arranged in the circumferential direction. A flange-shaped engaging protuberance 62a protrudes outward from the proximal end portion of the conductive tube 62. The engaging protuberance 62a is coupled it is inserted and fitted in an engaging groove portion 60d of the inner tube portion 60b of the connecting member 60 by means of the spring force of the conductive tube 62. Thus, the conductive tube 62 is supported on the connecting member 60 so as to be rotatable around the axis and fixed in the axial direction.

Formed on the distal end side of the conductive tube 62, moreover, is a small-diameter tube portion 62b that is inserted in the slider mounting member 51. The inside diameter of the small-diameter tube portion 62b is greater than a maximum diameter on the proximal end side of the vibration transmitting member 9, that is, the diameter of a maximum-diameter portion 9e of the proximal end portion of a horn portion 9d. When the slider mounting member 51 moves in the axial direction as the slider 54 is slid to open or close the movable handle 14, the slider mounting member 51 slides along the small-diameter tube portion 62b of the conductive tube 62.

Positioning flat portions 9f1 and 9f2, which are obtained by cutting opposite side faces of a circular cross section flat, as shown in FIG. 5D, are formed in a position for a node of vibration on the extreme proximal end side of the vibration transmitting member 9, as shown in FIG. 5A. Formed in this position is an odd-profile portion 9g having a noncircular cross section.

Further, a ring-shaped conductive member 63 of conductive material rubber, such as conductive silicone rubber, is attached to the inner peripheral surface of the distal end portion of the small-diameter tube portion 62b of the conductive tube 62 in a position near a node of vibration of the vibration transmitting member 9. An odd-shaped hole portion 63a corresponding to the odd-profile portion 9g of the vibration transmitting member 9 is formed in the inner peripheral surface of the conductive member 63. The odd-shaped hole portion 63a is formed having a circular hole portion 63b corresponding to a circular profile portion of the vibration transmitting member 9 and flat portions 63c1 and 63c2 corresponding to the flat portions 9fl and 9f2, respectively. In assembling the ultrasonic operating apparatus 1, the odd-profile portion 9g of the vibration transmitting member 9 is caused to engage the odd-shaped hole portion 63a of the conductive member 63. This engaging portion forms a first dislocation preventing portion 64 for preventing dislocation between the respective joint surfaces of the vibration transmitting member 9 and the conductive member 63 in the rotating direction.

As shown in FIG. 3, moreover, positioning flat portions 62c1 and 62c2, which are obtained by cutting opposite side faces of a circular cross section flat, are formed on the outer peripheral surface of the small-diameter tube portion 62b of the conductive tube 62. Formed in this position is an odd-profile portion 62d having a noncircular cross section.

Further, an odd-shaped hole portion 51b corresponding to the odd-profile portion 62d of the conductive tube 62 is formed in the inner peripheral surface of the slider mounting member 51. The odd-shaped hole portion 51b is formed having a circular hole portion 51c corresponding to a circular profile portion of the small-diameter tube portion 62b of the conductive tube 62 and flat portions 51d1 and 51d2 corresponding to the flat portions 62c1 and 62c2, respectively. In assembling the ultrasonic operating apparatus 1, the odd-profile portion 62d of the conductive tube 62 is caused to engage the odd-shaped hole portion 51b of the slider mounting member 51. This engaging portion forms a second dislocation preventing portion 65 for preventing dislocation between the respective joint surfaces of the conductive tube 62 and the slider mounting member 51 in the rotating direction.

Thus, as the rotary knob 20 rotates, the force to rotate the rotary knob 20 is transmitted from the rotating barrel portion 42c that rotates integrally with the eccentric barrel 42 to the drive shaft connecting member 46 and the slider mounting member 51 via the rotary fixing pin 48, and then transmitted to the conductive tube 62 via the second dislocation preventing portion 65. Further, this handling force is transmitted to the vibration transmitting member 9 via the first dislocation preventing portion 64, whereupon the operating portion 9c and the jaw unit 24 are simultaneously rotated around the axis. While the rotary knob 20 is rotating, dislocation between the respective joint surfaces of the operating portion 9c and the jaw unit 24 in the rotating direction is prevented in a manner such that the jaw unit 24 is closed and joined to the operating portion 9c of the vibration transmitting member 9 by means of the second dislocation preventing portion 65 between the conductive tube 62 and the slider mounting member 51 and the first dislocation preventing portion 64 between the vibration transmitting member 9 and the conductive member 63.

Further, a second odd-profile portion 9h is formed in a position for a node of vibration near the extreme distal end portion of the vibration transmitting member 9. As shown in FIG. 5B, the second odd-profile portion 9h is formed having positioning flat portions 9i1 and 9i2 that are obtained by cutting opposite side faces of a circular cross section flat.

Furthermore, a spanner catch portion 9j for a driving tool is formed on the proximal end portion of the vibration transmitting member 9. As shown in FIG. 5E, the spanner catch portion 9j is formed having positioning flat portions 9k1 and 9k2 that are obtained by cutting opposite side faces of a circular cross section flat.

Further, an engaging hole portion 32c that engages the second odd-profile portion 9h of the vibration transmitting member 9 is formed on a tube wall portion corresponding to the second odd-profile portion 9h of the vibration transmitting member 9, that is, the inner peripheral surface of the coupling pipe 32, as shown in FIG. 8C. The engaging hole portion 32c is formed having positioning flat portions 32c1 and 32c2 that are obtained by flattening opposite side faces of a circular cross section to match the second odd-profile portion 9h of the vibration transmitting member 9. In assembling the ultrasonic operating apparatus 1, the second odd-profile portion 9h of the vibration transmitting member 9 is caused to engage the engaging hole portion 32c of the coupling pipe 32. This engaging portion forms a third dislocation preventing portion 67 for preventing dislocation between the respective joint surfaces of the vibration transmitting member 9 and the coupling pipe 32.

Furthermore, a retaining ring 68 of a plastic material is fitted in the inner peripheral surface of the drive shaft connecting member 46. The inner peripheral surface of the retaining ring 68 has a diameter smaller than the inside diameter of the drive shaft connecting member 46. Thus, the metallic drive shaft connecting member 46 can be prevented from directly touching the vibration transmitting member 9.

Further, a sealing rubber ring 69 is attached to the flange portion 51a of the slider mounting member 51. The rubber ring 69 serves to maintain airtightness between the slider mounting member 51 and the small diameter tube portion 62b of the conductive tube 62.

The following is a description of the functions of the configuration described above. The ultrasonic operating apparatus 1 of the present embodiment can be disassembled into three units, the handle unit 2, probe unit 3, and vibrator unit 4. In working the ultrasonic operating apparatus 1, the mounting screw 9a of the probe unit 3 is previously driven into and fixed to the internal thread portion of the tapped hole portion 7a of the vibrator unit 4, whereby the probe unit 3 and the vibrator unit 4 in the disassembled state are joined together. Thereafter, the integrated unit of the probe unit 3 and the vibrator unit 4 is attached to the handle unit 2.

In the operation for the attachment to the handle unit 2, the probe unit 3 is inserted into the handling portion body 12 through the rear end opening of the inner tube portion 60b of the connecting member 60 at the vibrator connecting portion 11 of the handling portion body 12 of the handle unit 2. Then, it is inserted into the inner pipe 28 of the insert portion covering tube 19.

As shown in FIG. 1, the operating portion 9c on the extreme distal end portion of the probe unit 3 is projected ahead of the insert sheath portion 2a. Thereupon, it can be set in a state such that the organism tissue can be held between itself and the jaw unit 24. As this is done, the unit joint portion 6 of the hand piece 5 of the vibrator unit 4 is removably coupled to the vibrator connecting portion 11 of the handling portion body 12 of the handle unit 2.

In coupling the unit joint portion 6, moreover, the unit joint portion 6 is inserted along the inner tube portion 60b of the connecting member 60 toward the distal end, as shown in FIG. 2. At this time, the engaging ring 8 of the unit joint portion 6 is elastically deformed as it gets over the engaging protuberance 61a of the fixing ring 61 of the vibrator connecting portion 11. When the distal end face of the unit joint portion 6 engages the contact surface of the joint portion 60c on the proximal end side of the connecting member 60, the engaging ring 8 of the hand piece 5 is pressed against the engaging protuberance 61a of the fixing ring 61 by an elastic force, thereby generating frictional force. Thereupon, the portions are detachably fixed. Forces in two directions, radial and axial, are generated in the respective contact portions of the engaging ring 8 and the engaging protuberance 61a of the fixing ring 61. The contact portions are firmly fixed in both axial and circumferential directions by means of a frictional force and engaging force that are produced by the forces in the two directions. In this state, the operation for assembling the handle unit 2, probe unit 3, and vibrator unit 4 in the combined state shown in FIG. 1 is finished.

In assembling the ultrasonic operating apparatus 1, the vibration transmitting member 9 is positioned in the inner pipe 28 by means of a plurality of rubber rings 9b that are set individually in positions for nodes of ultrasonic vibration of the vibration transmitting member 9. As this is done, the metallic inner pipe 28 is prevented from directly touching the vibration transmitting member 9 by means of the rubber rings 9b.

In assembling the ultrasonic operating apparatus 1, moreover, the odd-profile portion 62d of the conductive tube 62 is caused to engage the odd-shaped hole portion 51b of the slider mounting member 51. This engaging portion forms the second dislocation preventing portion 65 for preventing dislocation between the respective joint surfaces of the conductive tube 62 and the slider mounting member 51 in the rotating direction. Likewise, the odd-profile portion 9g of the vibration transmitting member 9 is caused to engage the odd-shaped hole portion 63a of the conductive member 63. This engaging portion forms the first dislocation preventing portion 64 for preventing dislocation between the respective joint surfaces of the vibration transmitting member 9 and the conductive member 63 in the rotating direction. Further, the second odd-profile portion 9h of the vibration transmitting member 9 is caused to engage the engaging hole portion 32c of the coupling pipe 32. This engaging portion forms the third dislocation preventing portion 67 for preventing dislocation between the respective joint surfaces of the vibration transmitting member 9 and the coupling pipe 32.

In working the ultrasonic operating apparatus 1, furthermore, the movable handle 14 is operated with the stationary handle 13 of the handle unit 2 gripped. As the movable handle 14 is operated in this manner, the handling rod 30 moves in the insert sheath portion 2b, thereby opening or closing the jaw body 24a that is attached to the tip 25 of the distal working portion 2a.

If the operation (closing operation) for gripping the movable handle 14 is carried out, the actuator pins 18 are rotated in the clockwise direction of FIG. 1 around the handle pivots 17. As this is done, the actuator pins 18 are advanced substantially straight to the distal end side within the ranges of their movement. This motion of the actuator pins 18 is transmitted to the slider 54 via the engaging portions between the actuator pins 18 and front and rear wall surfaces of the engaging groove 54a of the slider 54, whereupon the slider 54 is moved to the distal end side.

Further, this advancing motion of the slider 54 is transmitted from the slider mounting member 51 to the drive shaft connecting member 46 by means of the fixing screws 52. The handling rod 30 is pushed out toward the distal end by means of the drive shaft connecting member 46. Thereupon, the handling rod 30 advances in the insert portion covering tube 19. In consequence, the jaw unit 24 is fully closed with the tip 25 of the jaw unit 24 pressed against the operating portion 9c of the vibration transmitting member 9, as indicated by the solid line in FIG. 7. When the jaw unit 24 is in its fully-closed position, the seizing surface 25d on the underside of the tip 25 is intimately in contact with the contact surface 9m of the operating portion 9c of the vibration transmitting member 9 without a gap. In this state, the object of operation is held and pressurized between the tip 25 of the jaw unit 24 on the distal end of the handle unit 2 and the operating portion 9c, for use as an ultrasonic probe, on the distal end of the vibration transmitting member 9 of the probe unit 3. The object of operation is coagulated and incised with frictional heat that is generated by ultrasonic vibration.

When the object of operation is subjected to ultrasonic operation, moreover, the organism tissue is securely held to generate frictional heat with the jaw unit 24 closed, so that the operating portion 9c of the vibration transmitting member 9 is bent downward by a force of pressure from the tip 25. As this is done, the tip 25 swings around the supporting pins 27 of the jaw body 24a. Thus, the tip 25 can be pressed vertically against the inclined operating portion 9c. In consequence, the organism tissue can be securely coagulated and incised throughout the length of the tip 25.

Further, the limiting spring 53 is compressed to be shorter than its free length and subjected to the equipment load as it is mounted. When the movable handle 14 is closed, the jaw unit 24 can be directly opened or closed without subjecting the limiting spring 53 to elastic deformation with a handle operating force lighter than the equipment load. Thus the handling can be improved.

If a force heavier than the equipment load of the limiting spring 53 is applied when the movable handle 14 is closed, the limiting spring 53 is elastically deformed to prevent further transmission of the handle operating force. In consequence, the force from the jaw unit 24 that acts on the operating portion 9c of the vibration transmitting member 9 can never be excessive, so that excessive displacement of the operating portion 9c can be prevented to maintain the functions for incision and coagulation.

When the movable handle 14 in the fully-closed position is opened, moreover, the actuator pins 18 are rotated in the counterclockwise direction of FIG. 1 around the handle pivots 17. As the actuator pins 18 are moved in this manner, the slider 54 is moved backward.

This retreating motion of the slider 54 is transmitted from the slider mounting member 51 to the drive shaft connecting member 46 by means of the fixing screws 52. The handling rod 30 is pulled backward by means of the drive shaft connecting member 46. Thereupon, the handling rod 30 retreats in the insert portion covering tube 19, and a coupling pin 36 of a connecting member 34, along with the handling rod 30, also retreats parallel to the central axis of the insert portion covering tube 19. As this is done, the coupling pin 36 retreats sliding in the coupling pin 24d of the jaw body 24a. Thereupon, the tip 25 of the jaw unit 24 moves away from the vibration transmitting member 9, that is, the jaw unit 24 turns clockwise around the pivot pins 33, thereby opening with respect to the operating portion 9c of the vibration transmitting member 9, as indicated by imaginary line in FIG. 7.

When the rotary knob 20 is rotated, moreover, the force to rotate the rotary knob 20 is transmitted from the rotating barrel portion 42c rotating integrally with the rotating barrel portion 42c to the drive shaft connecting member 46 via the rotary fixing pin 48. Thus, the members that include the insert portion covering tube 19 and the members therein, the eccentric barrel 42 and the rotating barrel portion 42c mounted on the proximal end portion of the insert portion covering tube 19, and the rotary knob 20 can rotate integrally with the drive shaft connecting member 46 with respect to the handling portion body 12. Further, the force to rotate the rotary knob 45 is transmitted from the rotating barrel portion 42c to the drive shaft connecting member 46 via the rotary fixing pin 48, whereupon the slider mounting member 51, limiting spring 53, and slider 54 also rotate integrally with one another. Thus, the handling rod 30 can be prevented from being twisted.

As the rotary knob 20 rotates, furthermore, the force to rotate the rotary knob 20 is transmitted from the rotating barrel portion 42c that rotates integrally with the eccentric barrel 42 to the drive shaft connecting member 46 and the slider mounting member 51 via the rotary fixing pin 48, and then transmitted to the conductive tube 62 via the second dislocation preventing portion 65. Further, this handling force is transmitted to the vibration transmitting member 9 via the first dislocation preventing portion 64, whereupon the operating portion 9c and the jaw unit 24 are simultaneously rotated around the axis. While the rotary knob 20 is rotating, dislocation between the conductive tube 62 and the slider mounting member 51 in the rotating direction is prevented by means of the second dislocation preventing portion 65. Further, dislocation between the vibration transmitting member 9 and the conductive member 63 in the rotating direction is prevented by means of the first dislocation preventing portion 64. Furthermore, dislocation between the vibration transmitting member 9 and the coupling pipe 32 in the rotating direction is prevented by means of the third dislocation preventing portion 67. Thus, dislocation between the respective joint surfaces of the operating portion 9c and the jaw unit 24 in the rotating direction is prevented in a manner such that the jaw unit 24 is closed and joined to the operating portion 9c of the vibration transmitting member 9.

High-frequency current supplied from a high-frequency cable that is connected to the connecting portion 15c of the electrode pin 15 flows from the point portion 15d to the connecting member 60. Further, it flows through the conductive member 63 of conductive rubber and reaches the vibration transmitting member 9. Thereafter, it is discharged from the distal end of the operating portion 9c to carry out high-frequency operation.

The jaw holding member 31 and the outer pipe 21 of the insert portion covering tube 19 are metallic and electrically conductive. Further, the jaw holding member 31 and the insert portion covering tube 19 are pre-insulated by means of the coupling pipe 32 and the insulating tube 22, respectively. Thus, the high-frequency current is prevented from flowing to parts other than the object of operation.

For reuse sake, moreover, the ultrasonic operating apparatus 1 of the present embodiment is disassembled into three units, the handle unit 2, probe unit 3, and vibrator unit 4, after use. By doing this, each of the disassembled units including the handle unit 2, probe unit 3, and vibrator unit 4 can be positively cleaned with a brush or the like. Thus, the convenience of cleaning of the ultrasonic operating apparatus 1 can be improved.

In the jaw unit 24 of the present embodiment, moreover, the supporting pins 27 of the jaw body 24a can be drawn out of the insertion holes 101 and 102 of the tip 25 and the seizing portion mounting member 26, individually, in a manner such that the respective distal end portions of the arms 24b1 and 24b2 of the jaw body 24a are bent outward. Thus, the tip 25 and the seizing portion mounting member 26 of the jaw unit 24 can be removed from the jaw body 24a. If the tip 25 is worn away during use, therefore, the worn tip 25 is removed from between the respective distal end portions of the arms 24b1 and 24b2 of the jaw body 24a, and a new tip 25 is mounted between the respective distal end portions of the arms 24b1 and 24b2. By doing this, the tip 25 can be replaced with ease.

The above-described configuration produces the following effects. More specifically, in the present embodiment, the tip 25 and seizing portion mounting member 26 of the jaw unit 24 are removably coupled between the respective distal end portions of the arms 24b1 and 24b2 of the jaw body 24a. If the tip 25 is worn away, therefore, a new tip 25 can be mounted between the respective distal end portions of the arms 24b1 and 24b2 of the jaw body 24a after the worn tip 25 is removed from between the respective distal end portions of the arms 24b1 and 24b2 of the jaw body 24a. In consequence, the tip 25 can be replaced with ease. If the tip 25 of the jaw unit 24 is worn away and rendered unusable, the cost of parts replacement can be made lower than in the conventional case where all the parts that are assembled to the jaw unit 24 and unitized are replaced, and the running cost of the whole system of the ultrasonic operating apparatus 1 can be lowered.

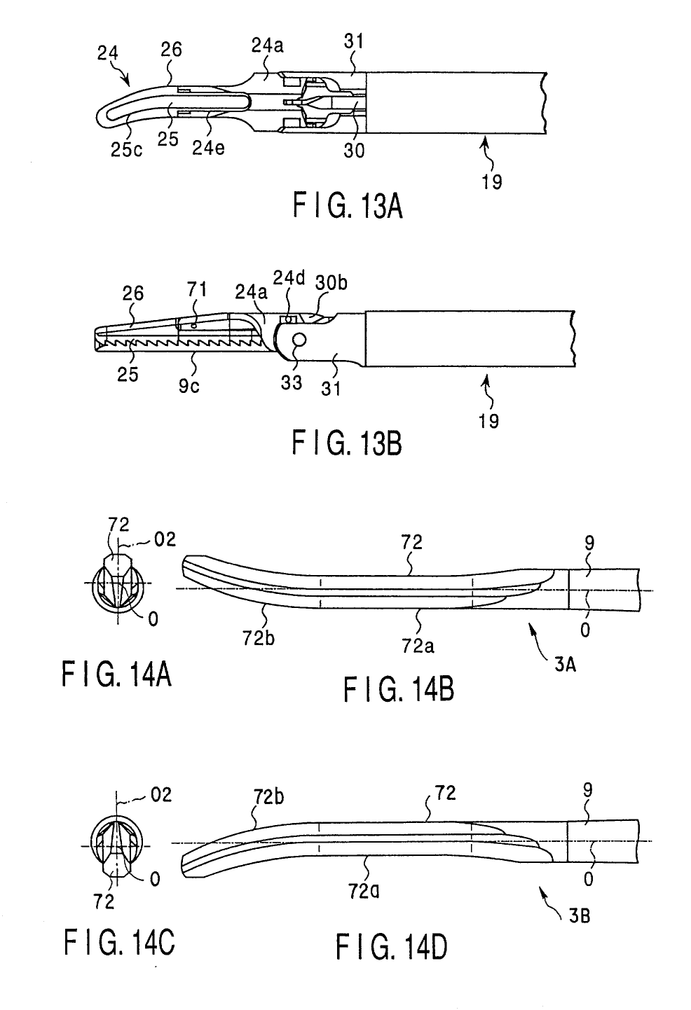

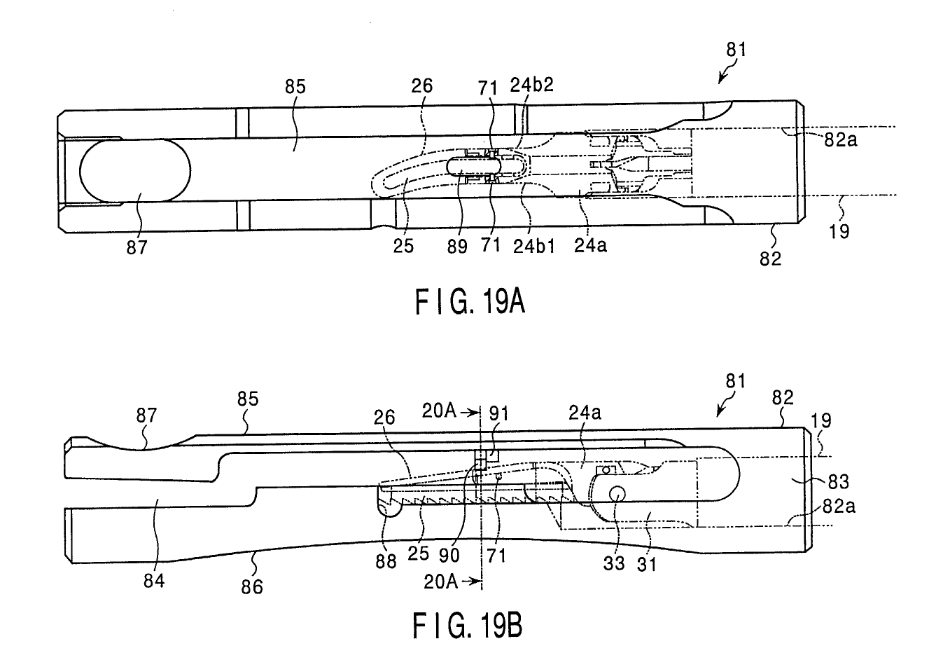

FIGS. 13A to 20B show a second embodiment of the present invention. The present embodiment is obtained by modifying the configuration of the ultrasonic operating apparatus 1 of the first embodiment (see FIGS. 1 to 12) in the following manner.

More specifically, the ultrasonic operating apparatus 1 of the present embodiment comprises a vibration transmitting member 9 having a distal end operating portion 72, as shown in FIGS. 14A and 14B. The operating portion 72 is provided with a straight portion 72a, which is extends substantially in a straight line along a center line 0 of a probe unit 3, and a curved portion 72b, which is gently curved in a circular arc to be deviated from the center line 0 of the probe unit 3. The curved portion 72b is formed on the distal end portion of the straight portion 72a.

As shown in FIG. 14A, moreover, the curved portion 72b is formed axisymmetrically with respect to the direction of a straight line 02 in which a jaw unit 24 is opened or closed. By inserting the probe unit 3 into a handle unit 2, as shown in FIGS. 14A and 14B, therefore, a rightward first probe unit 3A can be formed having the curved portion 72b curved in a rightward circular arc. By inserting the probe unit 3 into the handle unit 2 in a 180°-turned manner, on the other hand, a leftward second probe unit 3B can be formed having the distal end operating portion 72 of the vibration transmitting member 9 curved in a leftward circular arc, as shown in FIGS. 14C and 14D.

As shown in FIG. 17, moreover, a jaw body 24a of the jaw unit 24 is provided with a pair of arms 24b1 and 24b2, which are symmetrical with respect to the central axis of an insert portion and have pin insertion holes 74 in their respective distal end portions, individually. Supporting pins (support shaft portions) 71 for supporting a tip 25 are inserted in the pin insertion holes 74, individually. The respective distal end portions of the supporting pins 71 protrude inward from the arms 24b1 and 24b2, individually. Further, the respective proximal end portions of the supporting pins 71 are fixed in the respective pin insertion holes 74 of the arms 24b1 and 24b2, individually. On the distal end side of the pin insertion holes 74, furthermore, straight grooves 75 individually extend along the center line 0 of the probe unit 3B inside the arms 24b1 and 24b2.

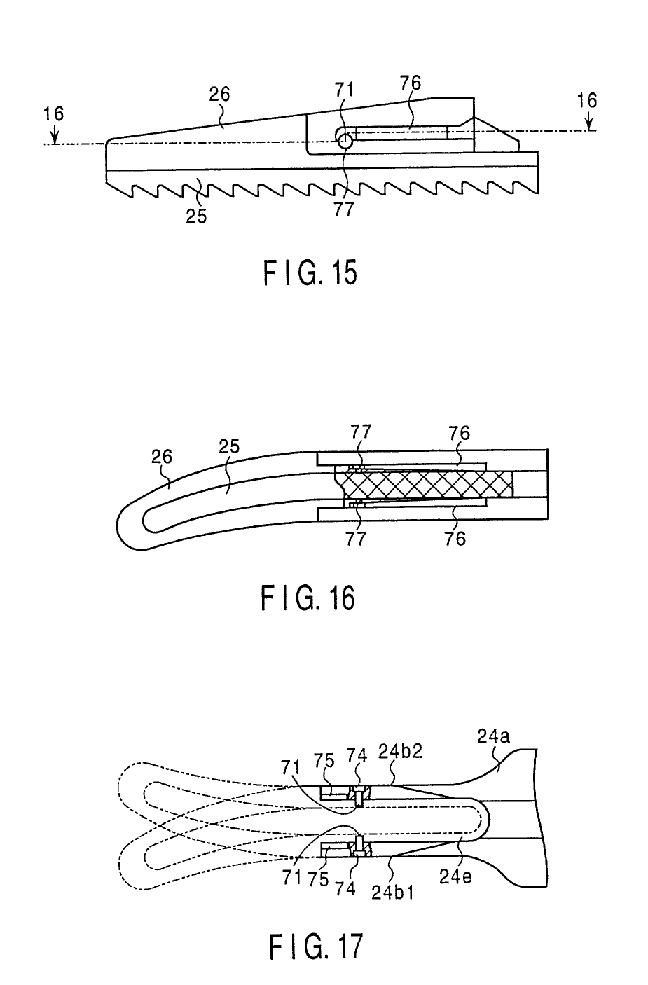

As shown in FIG. 15, that part of the tip 25 of the jaw unit 24 which is inserted in the slit 24e between the arms 24b1 and 24b2 of the jaw body 24a is provided with guide grooves 76 and mounting holes 77 for the supporting pins 71. The mounting holes 77 are located substantially in the central region of the tip 25 with respect to its longitudinal direction.

As shown in FIG. 16, moreover, the guide grooves 76 extend from the rear end position of the tip 25 to the position for the mounting holes 77. In attaching the tip 25 to the jaw body 24a, the supporting pins 71 are guided along the guide grooves 76 to the mounting holes 77, individually.

Further, each guide groove 76 is formed having a taper surface such that the groove depth gradually decreases from the rear end position of the tip 25 toward each mounting hole 77. The mounting hole 77 is located in a position where the groove depth of the guide groove 76 is minimal. Formed at the junction of the guide groove 76 and the mounting hole 77 is a click step for preventing the supporting pin 71 from slipping out of the mounting hole 77. Thus, in attaching the tip 25 to the jaw body 24a, the supporting pins 71 on the opposite sides are moved away from each other as the supporting pins 71 are moved along the respective taper surfaces of the guide grooves 76 toward the mounting holes 77. Thereupon, the supporting pins 71 get over the click steps and are removably inserted into the mounting holes 77.

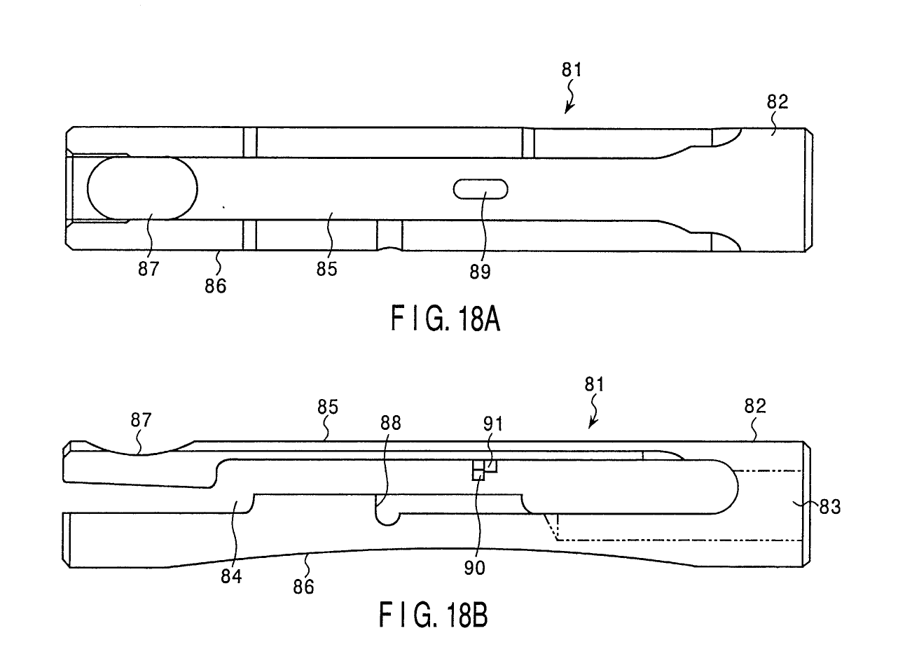

Provided according to the present embodiment, moreover, is a tip changing tool 81 shown in FIGS. 18A an 18B, which is used to remove the tip 25 from the jaw body 24a. A jig body 82 of the changing tool 81 is provided with an insertion hole 83 into which a distal working portion 2b of the ultrasonic operating apparatus 1 can be inserted and a stopper portion 88 for locating the position of insertion of the distal working portion 2b inserted in the insertion hole 83.

Furthermore, one end portion of a handling arm 85 is coupled to the inlet side of the insertion hole 83 of the jig body 82. As shown in FIG. 18B, a gap 84 of a given width is formed between the handling arm 85 and the jig body 82, covering the other region than their junction. The handling arm 85 is supported on the jig body 82 so as to be rockable around the junction as a hinge portion.

Further, a handgrip depression 86 is formed in the peripheral wall surface of the jig body 82 on the side opposite from the handling arm 85. Furthermore, a finger-rest depression 87 is formed on the free end side of the handling arm 85.

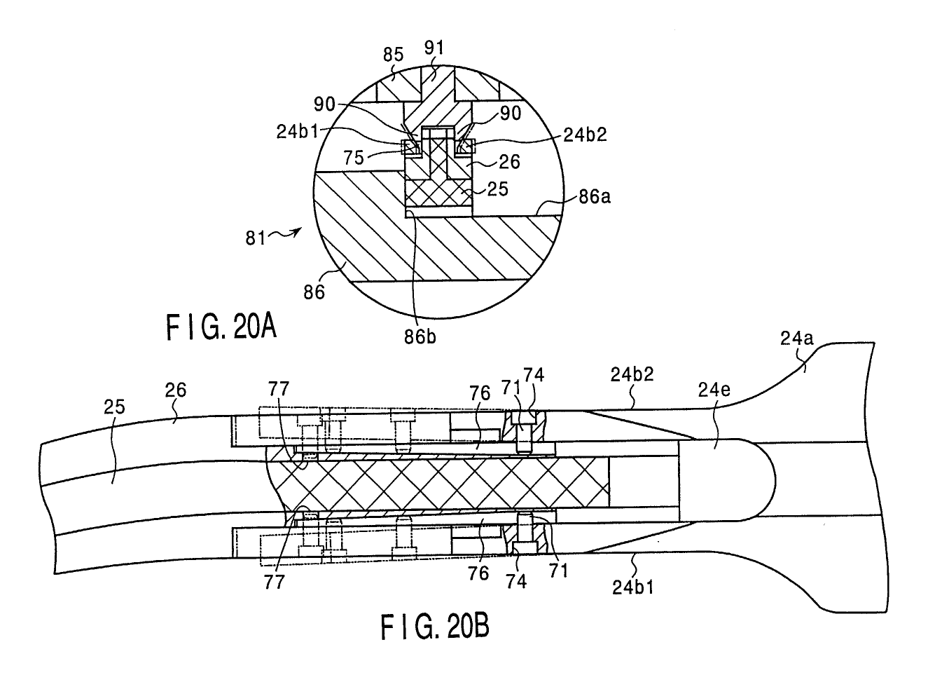

Further, a separating portion 89 is provided in the middle portion of the handling arm 85. As shown in FIG. 20A, the separating portion 89 is provided with a projecting member 91 that protrudes from the inner peripheral surface of the handling arm 85 toward the jig body 82. The distal end portion of the projecting member 91 is provided with a pair of wedge-shaped separating claws 90, left and right, which are spaced and opposed to each other. The separating claws 90 can be removably inserted into spaces between the tip 25 and the arms 24b1 and 24b2 on the opposite sides of the jaw body 24a of the distal working portion 2b as the handling arm 85 rocks. As the separating claws 90 are inserted into the spaces between the tip 25 and the arms 24b1 and 24b2, the arms 24b1 and 24b2 are individually pushed out and elastically deformed in a direction such that the space between the arms 24b1 and 24b2 widens. As the arms 24b1 and 24b2 are elastically deformed, the respective supporting pins 71 of the arms 24b1 and 24b2 are pushed out individually from the mounting holes 77 of the tip 25, as indicated by imaginary lines in FIG. 20B. As this is done, the respective supporting pins 71 of the arms 24b1 and 24b2 pass over the click steps and are drawn out of the mounting holes 77. Thereupon, the respective supporting pins 71 of the arms 24b1 and 24b2 are disengaged from the mounting holes 77 of the tip 25.

The following is a description of the functions of the present embodiment arranged in this manner. In attaching the tip 25 to the jaw body 24a, according to the present embodiment, the respective supporting pins 71 of the arms 24b1 and 24b2 are inserted into the guide grooves 76 of the tip 25 through rear end openings of the guide grooves 76, as shown in FIG. 15. As this is done, the respective supporting pins 71 of the arms 24b1 and 24b2 are guided along the guide grooves 76 to the mounting holes 77, individually.

As the respective supporting pins 71 of the arms 24b1 and 24b2 move, the supporting pins 71 are moved along the respective taper surfaces of the guide grooves 76 toward the distal ends. As this is done, the supporting pins 71 are moved along the respective taper surfaces of the guide grooves 76 in a direction such that the space between the supporting pins 71 on the opposite sides widens. Then, the supporting pins 71 get over the click steps and are removably inserted into the mounting holes 77 for engagement, whereupon the tip 25 is attached to the jaw body 24a.

Further, the tip changing tool 81 is used to remove the tip 25 from the jaw body 24a of the jaw unit 24. In working the tip changing tool 81, the position of insertion of the distal working portion 2b of the ultrasonic operating apparatus 1 is located by means of the stopper portion 88 with the distal working portion 2b inserted in the insertion hole 83 of the tip changing tool body 82. In this state, the handling arm 85 is rocked around the hinge portion on the inlet side of the insertion hole 83 of the jig body 82 with respect to the jig body 82. As the handling arm 85 is rocked in this manner, it is inserted into the space between the tip 25 and the arms 24b1 and 24b2 on the opposite sides of the jaw body 24a of the distal working portion 2b. As the separating claws 90 are inserted into the spaces between the tip 25 and the arms 24b1 and 24b2, the arms 24b1 and 24b2 are individually pushed out and elastically deformed in a direction such that the space between the arms 24b1 and 24b2 widens. As the arms 24b1 and 24b2 are elastically deformed, the respective supporting pins 71 of the arms 24b1 and 24b2 are pushed out individually from the mounting holes 77 of the tip 25, as indicated by the imaginary lines in FIG. 20B. As this is done, the respective supporting pins 71 of the arms 24b1 and 24b2 get over the click steps and are drawn out of the mounting holes 77. Thereupon, the respective supporting pins 71 of the arms 24b1 and 24b2 are disengaged from the mounting holes 77 of the tip 25. If the jig 81 is pulled toward the distal end in this state, the tip 25 can be removed integrally with the tip changing tool body 82 from the jaw body 24a of the jaw unit 24.

The above-described configuration produces the following effects. More specifically, in the present embodiment, the tip 25 of the jaw unit 24 is removably coupled between the respective distal end portions of the arms 24b1 and 24b2 of the jaw body 24a. If the tip 25 is worn away, therefore, a new tip 25 can be mounted between the respective distal end portions of the arms 24b1 and 24b2 of the jaw body 24a after the worn tip 25 is removed from between the respective distal end portions of the arms 24b1 and 24b2 of the jaw body 24a. In consequence, the tip 25 can be replaced with ease. If the tip 25 of the jaw unit 24 is worn away and rendered unusable, the cost of parts replacement can be made lower than in the conventional case where all the parts that are assembled to the jaw unit 24 and unitized are replaced, and the running cost of the whole system of the ultrasonic operating apparatus 1 can be lowered. Thus, since the tip 25 of the jaw unit 24 is of the replaceable type, more operations can be performed by only replacing low-priced parts, so that the cost can be lowered.

According to the present embodiment, moreover, the distal end operating portion 72 of the vibration transmitting member 9 is provided with the straight portion 72a and the curved portion 72b that is gently curved in a circular arc to be deviated from the center line 0 of the probe unit 3. As shown in FIG. 14A, the curved portion 72b is formed axisymmetrically with respect to the direction of the straight line 02 in which the jaw unit 24 is opened or closed. By inserting the probe unit 3 into the handle unit 2, as shown in FIGS. 14A and 14B, therefore, the rightward first probe unit 3A can be formed having the curved portion 72b curved in a rightward circular arc. By inserting the probe unit 3 into the handle unit 2 in a 180°-turned manner, on the other hand, the leftward second probe unit 3B can be formed having the distal end operating portion 72 of the vibration transmitting member 9 curved in a leftward circular arc, as shown in FIGS. 14C and 14D. A reversed operating device can be easily formed by attaching the jaw unit 24 that is curved in the same direction to match the shape of the probe unit 3. Thus, one probe unit 3 can be easily turned in two different directions, so that the number of types of operating devices to be assorted can be reduced and the cost can be lowered.

In removing the tip 25 from the jaw body 24a of the jaw unit 24 according to the present embodiment, furthermore, the tip 25 is removed integrally with the tip changing tool body 82 from the jaw body 24a of the jaw unit 24 by using the tip changing tool 81. Therefore, the operation for removing the particularly small-sized tip 25 from the jaw unit 24 can be carried out with ease, and this operation can be facilitated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic operating apparatus comprising:
an elongate insert portion capable of being inserted into a body cavity;
an operating portion located on a distal end portion of the insert portion, the operating portion being used to operate an organism tissue;
a handling portion coupled to a proximal end portion of said insert portion, the handling portion having therein an ultrasonic vibrator capable of generating ultrasonic vibration;
a covering tube located around said insert portion;
a vibration transmitting member passed through the covering tube, the vibration transmitting member having an ultrasonic probe on a side of said operating portion and capable of transmitting the ultrasonic vibration from said ultrasonic vibrator to said ultrasonic probe;
a jaw rockably supported opposite said ultrasonic probe and capable of seizing the organism tissue in conjunction with said ultrasonic probe;
a control handle located in said handling portion and capable of opening and closing said jaw with respect to said ultrasonic probe; and
a handling force transmitting member coupling said jaw and said control handle, and capable of transmitting handling force from said control handle to said jaw,
said jaw including a frame-shaped jaw body having at least supporting arms arranged individually on the opposite sides of a slot extending in an axial direction of said insert portion, a tip capable of seizing the organism tissue in conjunction with said ultrasonic probe, and a joint portion removably coupling said tip between said supporting arms of said jaw body.

2. An ultrasonic operating apparatus according to claim 1, wherein said ultrasonic probe has an asymmetric curved portion curved with respect to a central axis of said insert portion.

3. An ultrasonic operating apparatus according to claim 2, wherein said curved portion is formed symmetrically with respect to a direction in which said jaw is opened or closed.

4. An ultrasonic operating apparatus according to claim 1, wherein said jaw body is designed so that support shaft portions of said tip protrude inward from the respective distal end portions of said two supporting arms, and said tip has mounting holes into which said support shaft portions are removably inserted and guide grooves for guiding said support shaft portions to said mounting holes as said tip is attached to said jaw body, said guide grooves individually having taper surfaces for movement such that the space between the respective support shaft portions of said two supporting arms widens toward said mounting holes and click step portions for preventing said support shaft portions from slipping out of said mounting holes.

5. A tool for changing a tip of an ultrasonic operating apparatus, comprising:
a tip changing tool body having an insertion hole into which a distal operating portion of said ultrasonic operating apparatus is inserted and a stopper portion for being the position of insertion of said distal operating portion inserted in the insertion hole;
a handling arm coupled to said tool body so as to be rockable around a hinge portion located on the inlet side of said insertion hole of the tool body; and
wedge-shaped separating portions adapted to be removably inserted into spaces between the tip for seizing an organism tissue and supporting arms on the opposite sides of a jaw body of said distal operating portion as the handling arm rocks, thereby moving said supporting arms in a direction such that indented fitting portions of said supporting arms and said tip are disengaged from one another.
